(19) United States
(12) Patent Application Publication
(10) Pub. No.: US 2025/0379353 A1
(43) Pub. Date: Dec. 11, 2025

(54) MULTIANTENNA

(71) Applicant: LG INNOTEK CO., LTD, Seoul (KR)

(72) Inventors: Jong Min KIM, Seoul (KR); Yu Seon KIM, Seoul (KR); Youn Ung JEONG, Seoul (KR)

(73) Assignee: LG INNOTEK CO., LTD, Seoul (KR)

(21) Appl. No.: 18/875,558

(22) PCT Filed: Jun. 16, 2023
(86) PCT No.: PCT/KR2023/008409

§ 371 Date: Dec. 16, 2024

(30) Foreign Application Priority Data
Jun. 17, 2022 (KR) 10-2022-0073906

(51) Int. Cl. H01Q 1/52; H01Q 1/22; H01Q 1/48; H01Q 9/04

(52) U.S. Cl. CPC H01Q 1/521; H01Q 1/2291; H01Q 1/48; H01Q 9/0421

(57) ABSTRACT

A multiantenna of an embodiment includes a substrate; a ground arranged on one side of the substrate; and first and second antennas arranged spaced apart from each other in a first direction on the other side of the substrate, and facing the ground in a second direction crossing the first direction, wherein the first antenna comprises a first feeding line connected to the ground, the second antenna comprises a second feeding line connected to the ground and facing the first feeding line in the first direction, and the ground comprises a groove formed to extend in the second direction between the first feeding line and the second feeding line.

### TECHNICAL FIELD

Embodiments relate to a multiantenna.

### BACKGROUND ART

As devices using radio waves are diversified, a multiple-input multiple-output (MIMO) antenna is used in order to increase the capacity and efficiency thereof. In this case, however, the number of antennas increases in a confined space, which may cause electromagnetic interference and coupling between the antennas. Therefore, various research with the goal of securing isolation between antennas is underway.

### DISCLOSURE

### Technical Problem

Embodiments provide a multiantenna having high isolation between antennas.

### Technical Solution

A multiantenna according to an embodiment may include a substrate, a ground disposed on one side of the substrate, and first and second antennas disposed on another side of the substrate so as to be spaced apart from each other in a first direction and to be opposite the ground in a second direction intersecting the first direction, wherein the first antenna may include a first feeding line connected to the ground, the second antenna may include a second feeding line connected to the ground, the second feeding line being opposite the first feeding line in the first direction, and the ground may include a groove formed therein so as to extend in the second direction between the first feeding line and the second feeding line.

In an example, the depth of the groove in the second direction may be greater than the width of the groove in the first direction.

In an example, the width may be 100 μm or more, and the depth may be 200 μm or more.

In an example, the first feeding line and the second feeding line may have planar shapes symmetrical with each other in the first direction with respect to a virtual center line passing through the center of the groove and extending in the second direction.

In an example, the first antenna and the second antenna may have planar shapes symmetrical with each other in the first direction with respect to the virtual center line.

In an example, the substrate may include a first area overlapping the ground in a third direction intersecting each of the first and second directions and a second area overlapping the first and second antennas in the third direction, and the groove may be connected to the second area.

In an example, the first antenna and the second antenna may operate in the same frequency band.

In an example, a ratio of the depth (d) of the groove in the second direction to the length (L) of the ground in the second direction may be as follows.

$$\frac{1}{30} \leq \frac{d}{L} \leq \frac{1}{3}$$

In an example, each of the first and second antennas may have a planar inverted-F antenna structure.

In an example, one of the first and second antennas may be a Bluetooth antenna, and the remaining one of the first and second antennas may be a Wi-Fi antenna.

In an example, each of the first and second antennas may be a Bluetooth antenna or a Wi-Fi antenna.

In an example, the first antenna may include a first radiator connected to the first feeding line, and the second antenna may include a second radiator connected to the second feeding line.

In an example, the first feeding line may include a first feeding portion configured to receive current to be supplied to the first radiator, a first ground portion connected to the ground and disposed closer to the groove than the first feeding portion, and a first line disposed between the first feeding portion and the first ground portion, and the second feeding line may include a second feeding portion configured to receive current to be supplied to the second radiator, a second ground portion connected to the ground and disposed closer to the groove than the second feeding portion, and a second line disposed between the second feeding portion and the second ground portion.

In an example, the first ground portion and the second ground portion may have planar shapes symmetrical with each other in the first direction with respect to a virtual center line passing through the center of the groove and extending in the second direction.

In an example, the groove may overlap a space between the first ground portion and the second ground portion in the second direction.

In an example, a difference between the phase of the current fed to the first feeding line and the phase of the current fed to the second feeding line may be 180°.

In an example, the substrate may be exposed through the groove.

### Advantageous Effects

A multiantenna according to an embodiment has high isolation between antennas.

### DESCRIPTION OF DRAWINGS

FIG. 1 illustrates a front perspective view of a multiantenna according to an embodiment.

FIG. 2 illustrates a rear perspective view of the multiantenna shown in FIG. 1.

FIG. 3 illustrates a plan view of the multiantenna shown in FIGS. 1 and 2.

FIG. 4 illustrates an enlarged view of portion “A” shown in FIG. 3.

FIG. 5A shows a voltage standing wave ratio (VSWR) of a multiantenna according to a comparative example, and FIG. 5B shows a VSWR of the multiantenna according to the embodiment.

FIG. 6A shows insertion loss of the multiantenna according to the comparative example, and FIG. 6B shows insertion loss of the multiantenna according to the embodiment.

FIG. 7A shows the intensity of a field produced by coupling in the multiantenna according to the comparative example, and FIG. 7B shows the intensity of a field produced by coupling in the multiantenna according to the embodiment.

FIGS. 8A to 8D are views for explaining changes in beam direction in accordance with phase adjustment in the embodiment.

### BEST MODE

Hereinafter, the present disclosure will be described more fully hereinafter with reference to the accompanying drawings, in which various embodiments are shown. The examples, however, may be embodied in many different forms, and should not be construed as being limited to the embodiments set forth herein. Rather, these embodiments are provided so that this disclosure will be more thorough and complete, and will more fully convey the scope of the disclosure to those skilled in the art.

It will be understood that when an element is referred to as being “on” or “under” another element, it may be directly on/under the element, or one or more intervening elements may also be present. In addition, when an element is referred to as being “on” or “under”, “under the element” as well as “on the element” may be included based on the element.

In addition, relational terms, such as “first”, “second”, “on/upper part/above”, and “under/lower part/below”, are used only to distinguish between one subject or element and another subject or element, without necessarily requiring or involving any physical or logical relationship or sequence between the subjects or elements.

Hereinafter, a multiantenna 100 according to an embodiment will be described using the Cartesian coordinate system, but the embodiments are not limited thereto. That is, in the Cartesian coordinate system, the x-axis, the y-axis, and the z-axis are orthogonal to each other, but the embodiments are not limited thereto. That is, the x-axis, the y-axis, and the z-axis may intersect each other obliquely, rather than being orthogonal to each other. Hereinafter, for convenience of description, the x-axis direction will be referred to as a “first direction”, the y-axis direction will be referred to as a “second direction”, and the z-axis direction will be referred to as a “third direction”.

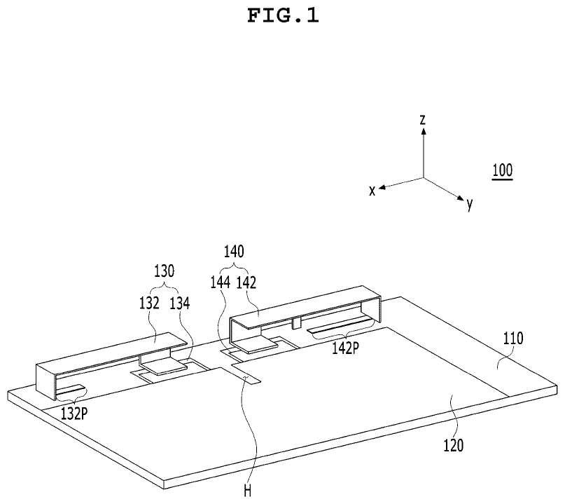

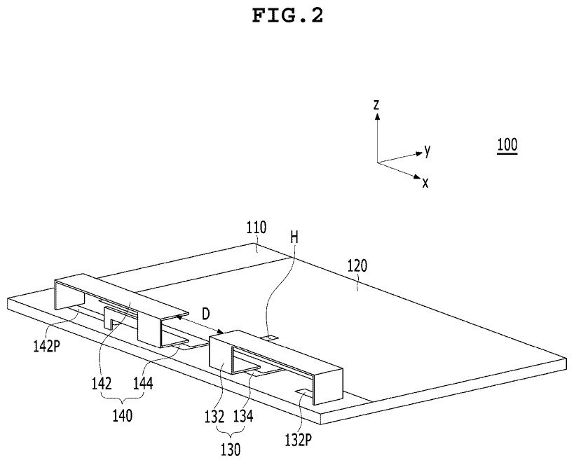

FIG. 1 illustrates a front perspective view of a multiantenna 100 according to an embodiment, and FIG. 2 illustrates a rear perspective view of the multiantenna 100 shown in FIG. 1.

The multiantenna 100 according to the embodiment may include a substrate (or antenna substrate) 110, a ground 120, and first and second antennas 130 and 140.

The ground 120 may be disposed on one side of the substrate 110.

The first and second antennas 130 and 140 may be disposed on the other side of the substrate 110 so as to be spaced apart from each other in the first direction, and may be disposed opposite the ground 120 in the second direction intersecting the first direction.

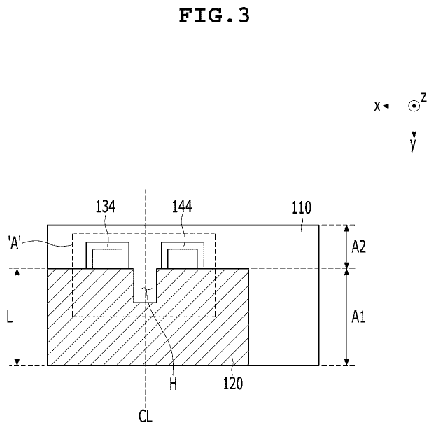

FIG. 3 illustrates a plan view of the multiantenna shown in FIGS. 1 and 2. Here, for convenience of description, illustration of first and second radiators 132 and 142 shown in FIGS. 1 and 2 is omitted in FIG. 3.

Referring to FIG. 3, the substrate 110 may include first and second areas A1 and A2. The first area A1 may be an area that overlaps the ground 110 in the third direction intersecting each of the first and second directions, and the second area A2 may be an area that overlaps the first and second antennas 130 and 140 in the third direction.

According to the embodiment, the first antenna 130 and the second antenna 140 may be antennas that operate in the same frequency band. In this case, in order to reduce the length of each of the first and second antennas 130 and 140, each of the first and second antennas 130 and 140 may have a planar inverted-F antenna (PIFA) structure, but the embodiments are not limited thereto. In the case of the planar inverted-F antenna structure, the antenna may be connected to the ground 120 and may operate at ¼ wavelength.

According to an embodiment, each of the first and second antennas 130 and 140 may be a Bluetooth antenna or a Wi-Fi antenna. In this case, the operating frequency of each of the Bluetooth antenna and the Wi-Fi antenna may be 2.45 GHZ.

According to another embodiment, one of the first and second antennas 130 and 140 may be a Bluetooth antenna, and the other thereof may be a Wi-Fi antenna.

However, the embodiments are not limited to any specific form of each of the first and second antennas 130 and 140. That is, each of the first and second antennas 130 and 140 may be any of various types of antennas, so long as the first and second antennas 130 and 140 are capable of operating at the same frequency. The multiantenna according to the embodiment may be a type of multiple-input multiple-output (MIMO) antenna.

According to the embodiment, the first antenna 130 may include a first feeding line 134, and the second antenna 140 may include a second feeding line 144.

Each of the first and second feeding lines 134 and 144 may be connected to the ground 120. In this way, the first and second antennas 130 and 140 may share the ground 120.

The first feeding line 134 and the second feeding line 144 may be disposed opposite each other in the first direction.

In addition, the first antenna 130 may further include a first radiator 132 connected to the first feeding line 134, and the second antenna further include a second radiator 142 connected to the second feeding line 144.

The material of each of the first radiator 132 and the second radiator 142 may be a metal. In this case, the material of a first portion 132P of the first radiator 132 that is connected to the substrate 110 may be different from the material of a second portion of the first radiator 132 except the first portion 132P, but the embodiments are not limited thereto. For example, the entirety of the first radiator 132 may be made of the same metal, and only the first portion 132P may be coated with copper or the like. In addition, the material of a third portion 142P of the second radiator 142 that is connected to the substrate 110 may be different from the material of a fourth portion of the second radiator 142 except the third portion 142P. For example, the entirety of the second radiator 142 may be made of the same metal, and only the third portion 142P may be coated with copper or the like.

In addition, a pattern may be inserted into each of the first and second radiators 132 and 142. The pattern of the first radiator 132 and the pattern of the second radiator 142 may be the same as or different from each other.

For example, if the first antenna 130 is a Bluetooth antenna and the second antenna 140 is a Wi-Fi antenna, a back pattern of the first radiator 132 may be different from a back pattern of the second radiator 142, as shown in FIG. 2. The reason for inserting the pattern into each of the first and second radiators 132 and 142 is to match the resonant frequencies of the first and second radiators 132 and 142.

According to the embodiment, the ground 120 may include a groove (or slot) H formed between the first feeding line 134 and the second feeding line 144 so as to extend in the second direction.

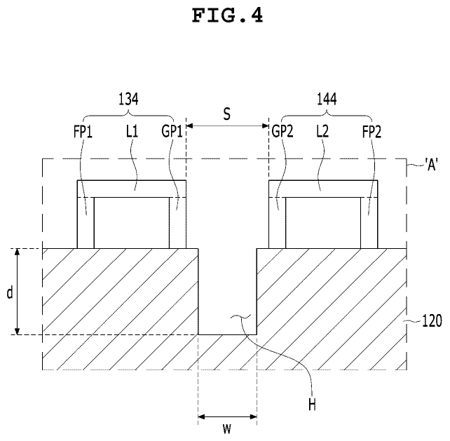

Hereinafter, the first and second antennas 130 and 140 will be described in detail with reference to FIG. 4 based on the groove H in the ground 120.

FIG. 4 illustrates an enlarged view of portion “A” shown in FIG. 3.

According to the embodiment, as a difference by which the depth (or length) d of the groove H in the second direction is greater than the width w of the groove H in the first direction increases, isolation between the first antenna 130 and the second antenna 140 may increase.

If the ratio of the depth d to the width w is less than 2, change in the isolation may be slight, and if the ratio of the depth d to the width w is greater than 10, the isolation may be saturated. Therefore, the ratio of the depth d to the width w may be set as shown in Equation 1 below.

$$2 \leq \frac{d}{w} \leq 10 \qquad [ Equation 1 ]$$

For example, the width w may be 100 μm or more, and the depth d may be 200 μm or more. However, the embodiments are not limited thereto.

In addition, if the ratio of the depth d of the groove H in the second direction to the length L of the ground 120 in the second direction is less than 1/30, change in the isolation may be slight, and if the ratio of the depth d to the length L is greater than ⅓, the isolation may be almost saturated, and the antenna gain may decrease due to reduction in the area of the ground. Therefore, the ratio of the depth d to the length L may be set as shown in Equation 2 below.

$$\frac{1}{30} \leq \frac{d}{L} \leq \frac{1}{3} \qquad [ Equation 2 ]$$

In addition, as shown in FIG. 3, the groove H in the ground 120 may be connected to the second area A2. That is, the substrate 110 may be exposed through the groove H. That is, the substrate 110 located in the groove H in the ground 120 may be a dielectric layer.

Referring to FIG. 4, the first feeding line 134 may include a first feeding portion FP1, a first ground portion GP1, and a first line L1.

The first feeding portion FP1 receives current to be supplied to the first radiator 132. The first feeding portion FP1 is electrically separated from the ground 120. The first ground portion GP1 may be connected to the ground 120 and may be disposed closer to the groove H than the first feeding portion FP1. The first line L1 may be disposed between the first feeding portion FP1 and the first ground portion GP1. Accordingly, a path along which the current fed to the first feeding portion FP1 flows to the ground 120 via the first line L1 and the first ground portion GP1 is formed, so that the current may be supplied to the first radiator 132 through the first feeding line 134.

The second feeding line 144 may include a second feeding portion FP2, a second ground portion GP2, and a second line L2.

The second feeding portion FP2 receives current to be supplied to the second radiator 142. The second feeding portion FP2 is electrically separated from the ground 120. The second ground portion GP2 may be connected to the ground 120 and may be disposed closer to the groove H than the second feeding portion FP2. The second line L2 may be disposed between the second feeding portion FP2 and the second ground portion GP2. Accordingly, a path along which the current fed to the second feeding portion FP2 flows to the ground 120 via the second line L2 and the second ground portion GP2 is formed, so that the current may be supplied to the second radiator 142 through the second feeding line 144.

For example, current may be supplied from an integrated circuit (not shown) to each of the first and second feeding portions FP1 and FP2 via an RF line (not shown). The integrated circuit and the RF line may be disposed on the substrate 110 so as to be electrically insulated from the ground 120.

A difference between the phase of the current fed to the first feeding line 134 and the phase of the current fed to the second feeding line 144 may be 180°.

The groove H may be formed to overlap a space S between the first ground portion GP1 and the second ground portion GP2 in the second direction.

According to the embodiment, the first ground portion GP1 and the second ground portion GP2 may have planar shapes symmetrical with each other in the first direction with respect to a virtual center line CL that passes through the center of the groove H and extends in the second direction.

Alternatively, the first feeding line 134 and the second feeding line 144 may have planar shapes symmetrical with each other in the first direction with respect to the virtual center line CL.

Alternatively, the first antenna 130 and the second antenna 140 may have planar shapes symmetrical with each other in the first direction with respect to the virtual center line CL.

Hereinafter, a multiantenna according to a comparative example and the multiantenna according to the embodiment will be described with reference to the accompanying drawings.

The multiantenna according to the comparative example is set to have the same configuration as the multiantenna according to the embodiment, except that the ground 120 does not have the groove H.

In the case of the multiantenna according to the comparative example, if the resonant frequencies of the first and second antennas 130 and 140 that operate in the same frequency band are the same as each other, as a separation distance (D in FIG. 2) between the first antenna 130 and the second antenna 140 in the first direction decreases, isolation between the first antenna 130 and the second antenna 140 may decrease, and thus interference between the antennas, i.e., coupling, may occur seriously.

In contrast, in the case of the multiantenna according to the embodiment, the groove H is formed in the ground 120, which is shared by the first antenna 130 and the second antenna 140, at a position between the first ground portion GP1 and the second ground portion GP2, thereby decoupling the two antennas 130 and 140. That is, current distribution is changed by the groove H, and thus coupling change is induced. Accordingly, interference between the first and second antennas 130 and 140 may be suppressed. That is, isolation between the first and second antennas 130 and 140 may be improved.

The isolation between the first and second antennas 130 and 140 may be influenced by the width w and the depth d of the groove H. Particularly, in the embodiment, the width w and the depth d of the groove H may be set taking into consideration that, as the ratio of the depth d of the groove H to the width w of the groove H increases, interference between the first and second antennas 130 and 140 is further suppressed.

The multiantenna according to the comparative example is set such that the antennas 130 and 140, the feeding lines 134 and 144, or the ground portions GP1 and GP2 are not symmetrical with each other with respect to the virtual center line CL.

In contrast, in the case of the multiantenna according to the embodiment, the antennas 130 and 140, the feeding lines 134 and 144, or the ground portions GP1 and GP2 are symmetrical with each other with respect to the virtual center line CL. Accordingly, the impedance of the second antenna 140 with respect to the first antenna 130 and the impedance of the first antenna 130 with respect to the second antenna 140 may be equal to each other, and thus coupling may be effectively controlled.

In addition, in the embodiment, even if the antennas 130 and 140, the feeding lines 134 and 144, or the ground portions GP1 and GP2 are not symmetrical with each other with respect to the virtual center line CL, the isolation between the first and second antennas 130 and 140 may be greater than that of the comparative example due to the presence of the groove H, as described above.

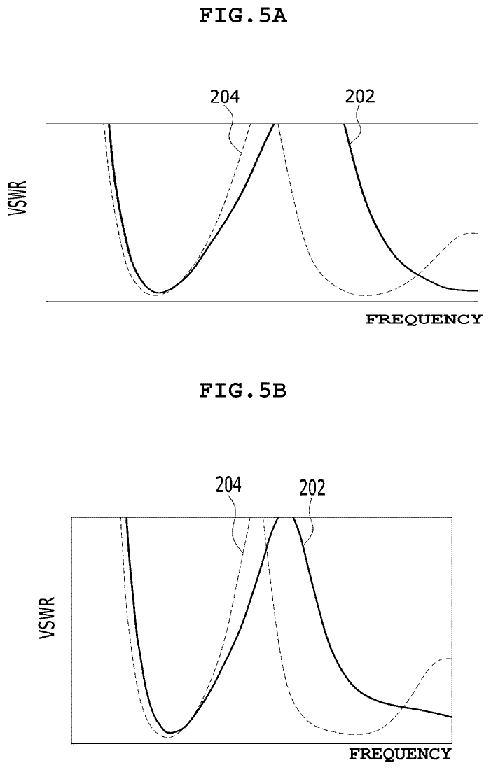

FIG. 5A shows a voltage standing wave ratio (VSWR) of the multiantenna according to the comparative example, and FIG. 5B shows a VSWR of the multiantenna according to the embodiment. In each graph, the horizontal axis represents frequency, and the vertical axis represents VSWR. In addition, reference numeral 202 represents the VSWR of the first antenna 130, and reference numeral 204 represents the VSWR of the second antenna 140.

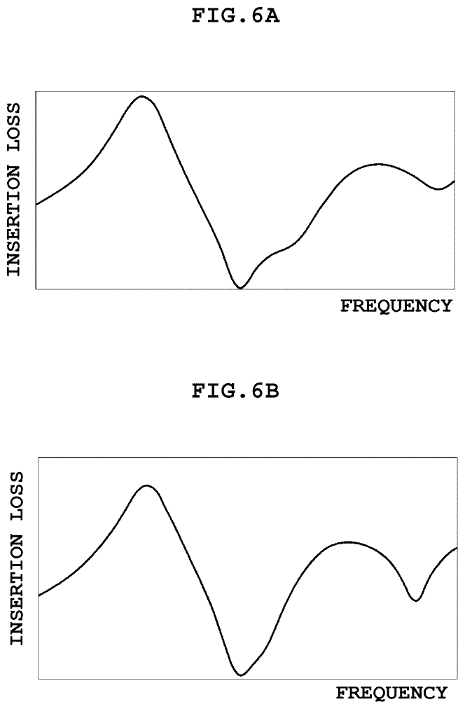

FIG. 6A shows insertion loss of the multiantenna according to the comparative example, and FIG. 6B shows insertion loss of the multiantenna according to the embodiment. In each graph, the horizontal axis represents frequency, and the vertical axis represents insertion loss.

In general, as the VSWR decreases, return loss decreases, and thus resonance occurs more easily at a specific frequency. As insertion loss decreases, isolation increases.

Even when the VSWR in the embodiment is lower than or similar to that in the comparative example, as shown in FIGS. 5A and 5B, the insertion loss in the embodiment is lower than that in the comparative example, as shown in FIGS. 6A and 6B, and thus the isolation in the embodiment is higher than that in the comparative example. That is, the multiantenna of the embodiment has improved isolation between the antennas.

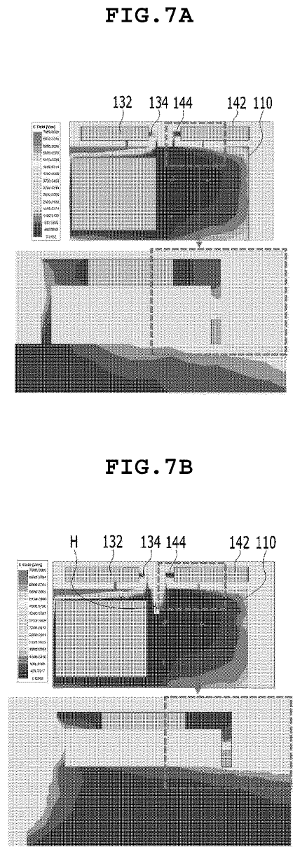

FIG. 7A shows the intensity of a field produced by coupling in the multiantenna according to the comparative example, and FIG. 7B shows the intensity of a field produced by coupling in the multiantenna according to the embodiment.

It may be seen that the intensity of a field produced by coupling in the embodiment shown in FIG. 7B is lower than the intensity of a field produced by coupling in the comparative example shown in FIG. 7A. When the intensity of a field is reduced, isolation is improved. Based thereon, it may also be seen that the isolation in the embodiment is improved compared to that in the comparative example.

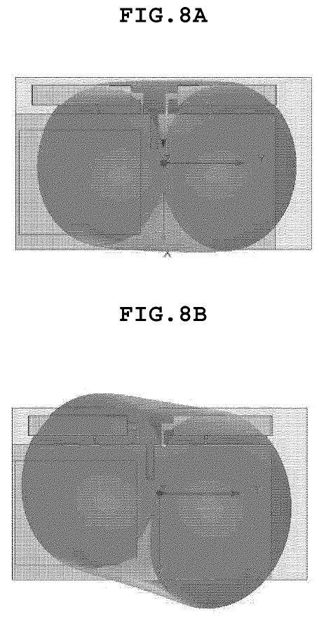

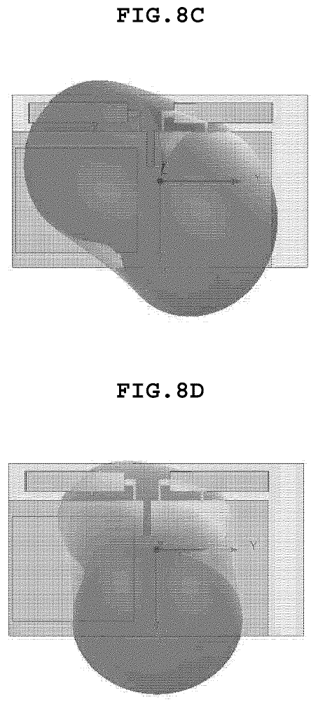

FIGS. 8A to 8D are views for explaining changes in beam direction in accordance with phase adjustment in the embodiment.

In a multiantenna, a beam direction may be changed by the shape of antennas or the phase in an array antenna.

According to the embodiment, in order to improve the gain of the multiantenna and control the beam direction, the phase of the current fed to the first antenna 130 (hereinafter referred to as a “first phase”) and the phase of the current fed to the second antenna 140 (hereinafter referred to as a “second phase”) may be adjusted to be different from each other.

When each of the first phase and the second phase is 0°, the beam direction is 0°, as shown in FIG. 8A, and the gain is +2.19 dBi.

In addition, when the first phase is 0° and the second phase is 45°, the beam direction is 35°, as shown in FIG. 8B, and the gain is +2.1 dBi.

In addition, when the first phase is 0° and the second phase is 90°, the beam direction is 62°, as shown in FIG. 8C, and the gain is +2.4 dBi.

In addition, when the first phase is 0° and the second phase is 180°, the beam direction is 83°, as shown in FIG. 8D, and the gain is +4.8 dBi.

As described above, when the difference between the first phase and the second phase, i.e., the phase difference, is 180°, the gain has the maximum value.

When the groove H is present in the ground 120 as in the embodiment, it is possible to change the beam direction and to maximize the gain by adjusting the phases of currents fed to the first and second antennas 130 and 140 to be different from each other, compared to when the groove H is not present in the ground 120. Therefore, according to the embodiment, it is possible to maximize the gain by adjusting the difference between the first phase and the second phase to be 180°.

The multiantenna according to the embodiment described above may be applied when there are a plurality of antennas using the same frequency band in televisions, portable terminals, etc.

While the present disclosure has been particularly shown and described with reference to exemplary embodiments thereof, these embodiments are only proposed for illustrative purposes, and do not restrict the present disclosure, and it will be apparent to those skilled in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

### MODE FOR INVENTION

Various embodiments have been described in the best mode for carrying out the disclosure.

### INDUSTRIAL APPLICABILITY

A multiantenna according to the embodiment may be used in various communication devices using radio waves, e.g., televisions or portable terminals.

1. A multiantenna, comprising:
a substrate;
a ground disposed on one side of the substrate; and
first and second antennas disposed on another side of the substrate so as to be spaced apart from each other in a first direction and to be opposite the ground in a second direction intersecting the first direction,
wherein the first antenna includes a first feeding line connected to the ground,
wherein the second antenna includes a second feeding line connected to the ground, the second feeding line being opposite the first feeding line in the first direction, and
wherein the ground includes a groove formed therein so as to extend in the second direction between the first feeding line and the second feeding line.

2. The multiantenna according to claim 1, wherein a depth of the groove in the second direction is greater than a width of the groove in the first direction.

3. The multiantenna according to claim 2, wherein the width is 100 μm or more, and the depth is 200 μm or more.

4. The multiantenna according to claim 1, wherein the first feeding line and the second feeding line have planar shapes symmetrical with each other in the first direction with respect to a virtual center line passing through a center of the groove and extending in the second direction.

5. The multiantenna according to claim 4, wherein the first antenna and the second antenna have planar shapes symmetrical with each other in the first direction with respect to the virtual center line.

6. The multiantenna according to claim 1, wherein the substrate includes:
a first area overlapping the ground in a third direction intersecting each of the first and second directions; and
a second area overlapping the first and second antennas in the third direction, and
wherein the groove is connected to the second area.

7. The multiantenna according to claim 1, wherein the first antenna and the second antenna operate in the same frequency band.

8. The multiantenna according to claim 1, wherein a ratio of a depth (d) of the groove in the second direction to a length (L) of the ground in the second direction is as follows.
$$\frac{1}{30} \leq \frac{d}{L} \leq \frac{1}{3}$$

9. The multiantenna according to claim 1, wherein each of the first and second antennas has a planar inverted-F antenna structure.

10. The multiantenna according to claim 1, wherein one of the first and second antennas is a Bluetooth antenna, and a remaining one of the first and second antennas is a Wi-Fi antenna.

11. The multiantenna according to claim 1, wherein each of the first and second antennas is a Bluetooth antenna or a Wi-Fi antenna.

12. The multiantenna according to claim 1, wherein the first antenna includes a first radiator connected to the first feeding line.

13. The multiantenna according to claim 12, wherein the second antenna includes a second radiator connected to the second feeding line.

14. The multiantenna according to claim 13, wherein the first feeding line comprises:
a first feeding portion configured to receive current to be supplied to the first radiator;
a first ground portion connected to the ground and disposed closer to the groove than the first feeding portion; and
a first line disposed between the first feeding portion and the first ground portion.

15. The multiantenna according to claim 14, wherein the second feeding line comprises:
a second feeding portion configured to receive current to be supplied to the second radiator;
a second ground portion connected to the ground and disposed closer to the groove than the second feeding portion; and
a second line disposed between the second feeding portion and the second ground portion.

16. The multiantenna according to claim 15, wherein the first ground portion and the second ground portion have planar shapes symmetrical with each other in the first direction with respect to a virtual center line passing through a center of the groove and extending in the second direction.

17. The multiantenna according to claim 15, wherein the groove overlaps a space between the first ground portion and the second ground portion in the second direction.

18. The multiantenna according to claim 15, wherein
a difference between the phase of the current fed to the first feeding line and the phase of the current fed to the second feeding line is 180°.

19. The multiantenna according to claim 1, wherein the substrate is exposed through the groove.
